(19) United States
(12) Patent Application Publication
(10) Pub. No.: US 2025/0045384 A1
(43) Pub. Date: Feb. 6, 2025

(54) EMBEDDED CONTROLLER SECURITY ASSURANCE

(71) Applicant: Dell Products L.P., Round Rock, TX (US)

(72) Inventors: Ibrahim SAYYED, Georgetown, TX (US); Charles D. ROBISON, Buford, GA (US); Anand Prakash JOSHI, Round Rock, TX (US)

(73) Assignee: Dell Products L.P., Round Rock, TX (US)

(21) Appl. No.: 18/364,784

(22) Filed: Aug. 3, 2023

(51) Int. Cl. G06F 21/55; G06F 21/57

(52) U.S. Cl. CPC G06F 21/554; G06F 21/552; G06F 21/572

(57) ABSTRACT

Disclosed systems and methods employ an embedded controller (EC) to monitor password activity and, responsive to detecting the password activity satisfying a criterion associated with a security policy managed by the EC, take action to restrict access to and/or operation of the platform in accordance with the security policy. The monitoring of password activity may include monitoring unsuccessful password change and password unlock attempts in both a preboot and runtime operating environment and within any of various available boot paths including, as examples, an operating system (OS) boot path, a network OS boot path, and a service OS (SOS) boot path. The OS boot source may be one of various telemetry events reported to a cloud-based risk assessment engine. Monitoring password change and password unlock attempts may include monitoring how many unsuccessful password change and unlock attempts have occurred since a most recent successful password change or password unlock attempt.

### TECHNICAL FIELD

The present disclosure pertains to information handling systems and, more particularly, securing systems against vulnerabilities.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, including, laptop, desktop, and server class systems, may be vulnerable to brute force attacks. A brute-force attack occurs when an attacker attempts to determine a password by systematically identifying and submitting new password candidates until the correct password is eventually found.

Preboot basic input/output system (BIOS) access security has been offered through various means of pre-operating system (OS) passwords and challenges requiring a user to authenticate before system access is granted. Different passwords may be staged at various stages of system boot, including admin password, system password, master passwords, etc. When any of these passwords are set and configured by users, intruders may attempt to unlock without user permission to gain system access. This can happen when the attacker has physical access to a platform or remotely during OS runtime operation.

In current systems, unlock or password change attempts have not been monitored in both preboot and runtime operating environments such as a System Management Mode (SMM) operating environment. In addition, BIOS password unlock attempts have not been reported to OS agents in normal operations or recovery operations. Generally, when unlock attempts reach a predetermined and hard-coded threshold, the system simply reboots. Information technology (IT) administrators are not provided with methods to tune thresholds and push policies for restricting system operation and hardening critical resource access.

### SUMMARY

Disclosed subject matter supports embedded controller (EC)-based mechanisms to track and monitor password unlock/change attempts covering both preboot and OS runtime operating environments. Disclosed ECs manage security policies and act per policy to harden system access or system operation when specified criteria and/or thresholds are satisfied or exceeded. In at least some embodiments, the security policies may be tuned or updated dynamically based on a security metric indicative of the platform's risk level.

Disclosed resources and methods may present unlock attempts and other password activity across every supported boot path, e.g., OS boot path, Service OS (SOS) boot path, and network OS boot path. In some embodiments, the boot source itself is monitored as a telemetry event.

In some embodiments, disclosed features enforce OS sign-on including cloud infrastructure-based login and step-up authentication for proof of presence when BIOS password unlock attempts exceed a specified threshold. In addition, embodiments may publish brute force attack attempt information, with time and date data, at an early BIOS level and keep the platform in a locked state until a cloud-issued token is received.

In at least some embodiments, disclosed subject matter integrates BIOS password anti-hammer and reporting at OS sign-on and supports an EC harden method to control and manage IT-pushed security policies to lock-down a boot path, forcing mitigation at OS & cloud level. Scalable attacks may be prevented through cloud-based proof of presence, which is beneficial because the device has been verified under attack and thus local authentication cannot be trusted.

Accordingly, in one aspect, disclosed information handling systems, referred to herein simply as platforms, and methods addressing the previously described issues include a central processing unit (CPU), an EC communicatively coupled to the CPU, and a computer readable medium, e.g., random access or nonvolatile memory resources, including instructions that, when executed, cause the EC to perform operations including monitoring password activity and, responsive to detecting the password activity satisfying a criterion defined, maintained, or otherwise associated with a security policy, taking action to restrict access to and/or operation of the platform in accordance with the security policy.

The monitoring of password activity may include monitoring unsuccessful password change and password unlock attempts in both a preboot and runtime operating environment and within any of various available boot paths including, as examples, an OS boot path, a network OS boot path, and a service OS (SOS) boot path. In at least some embodiments, the OS boot source is one of various telemetry events reported to a cloud-based risk assessment engine. In some embodiments, monitoring password change and password unlock attempts includes monitoring how many unsuccessful password change and unlock attempts have occurred since a most recent successful password change or password unlock attempt.

In some embodiments, the action taken to restrict access to or operation of the platform may include, as non-limiting examples, enforcing an OS sign on module, enforcing a cloud based login with proof of presence, preventing boot departures, and so forth.

Embodiments may further include or support advertising brute force attack attempts with time and date information and maintaining the platform in a locked state until, for example, a cloud-issued token is received. Responsive to receiving, from a cloud based risk assessment engine, risk assessment information indicative of a risk level, embodiments may dynamically tune the criterion in accordance with the risk level.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates elements of an information handling system in accordance with disclosed subject matter for EC-based security assurance features;

FIG. 2 is a flow diagram illustrating an EC-based security method; and

FIG. 3 is a block diagram illustrating selected features of an information handling system suitable for use in conjunction with the subject matter disclosed in reference to FIG. 1 and FIG. 2.

### DETAILED DESCRIPTION

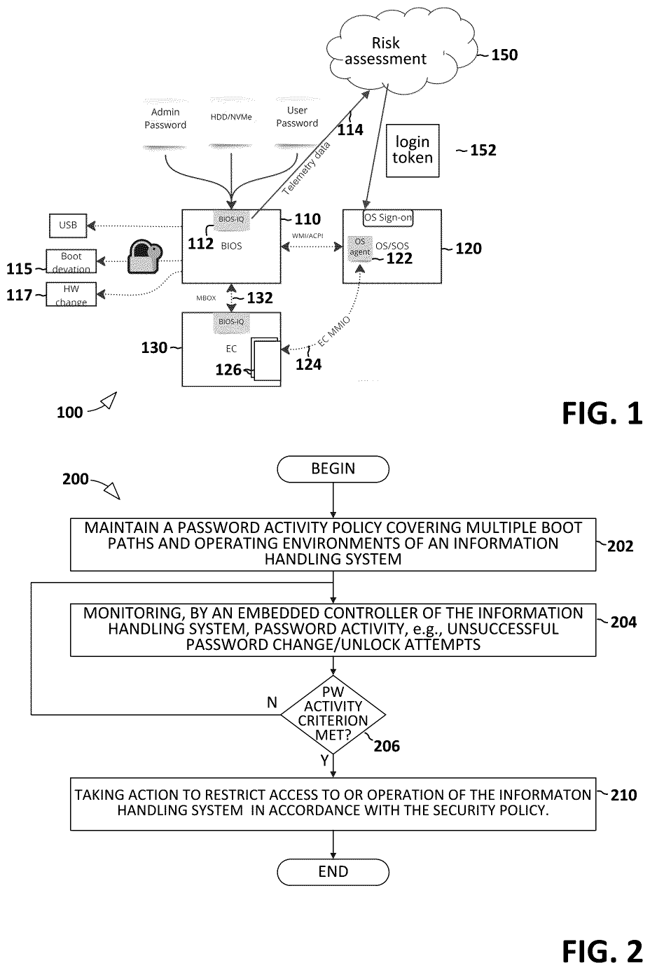

Exemplary embodiments and their advantages are best understood by reference to FIGS. 1-3, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates elements and operation of an information handling system, referred to herein simply as a platform 100, in which an EC 130 of platform 100 monitors password activity and manages and enforces one or more password security policies across multiple boot paths and multiple operating environments of platform 100.

The elements of platform 100 depicted in FIG. 1 include a BIOS 110, an OS/SOS space 120, and EC 130. FIG. 1 illustrates EC 130 communicatively coupled to BIOS 110 and to an OS agent 122, such as a credential provider, within Os/SOS space 120. As depicted in FIG. 1, OS agent 122 is accessible to EC 130 via a memory mapped I/O (MMIO) channel 124 while EC 130 communicates with BIOS 110 via MBOX communication 132. As depicted in FIG. 1, BIOS 110 includes a BIOS-IQ component 112 capable of capturing telemetry data 114 generated by platform 100 and transmitting the telemetry data to a cloud-based risk assessment resource 150. FIG. 1 conveys that BIOS 110 may support and manage access to one or more boot deviations 115 and may be configured to detect hardware changes 117. The telemetry data may include, in at least some embodiments, password activity data including password activity data signaling successful and unsuccessful attempts to change or unlock any preboot or OS login password supported by the platform.

Risk assessment resource 150 may determine a risk assessment metric, based at least in part on the telemetry data 114. Risk assessment resource 150 may be further provisioned to trigger step up authentication measures for proof of presence based on the risk metric in accordance with one or more security policies 126 maintained by EC 130. Risk assessment resource 150 may also be enabled to generate and transmit (152) a login token For purposes of illustration, an exemplary security policy 114 may monitor for a state in which a BIOS preboot anti-hammer figuration is enabled while password activity satisfying a specified threshold is detected. The security policy 114 may include one or more actions to be taken upon stratifying the applicable conditions. For example, an exemplary policy may respond to satisfaction of a password activity threshold by prohibiting boot deviations, e.g., booting from a USB device, and imposing or requiring cloud-based step up authentication for proof of presence as a prerequisite to continuing the boot sequence. Referring now to FIG. 2, a flow diagram illustrates a security method 200 in accordance with disclosed subject matter. The method 200 illustrated in FIG. 2 includes maintaining (202) a password activity policy covering multiple boot paths and operating environments of an information handling system. The illustrated method further includes monitoring (204), with an embedded controller of the information handling system, password activity, e.g., unsuccessful password change/unlock attempts. If (206) monitored password activity satisfies a specified criteria, then one or more policy-specified actions may be taken (210) to restrict access to or operation of the platform in accordance with the applicable policy.

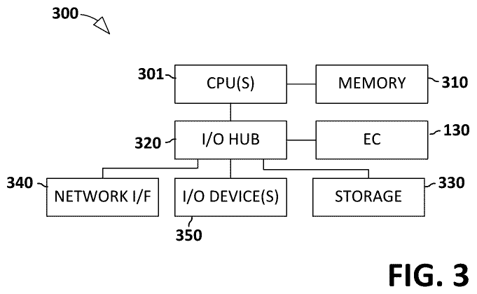

Referring now to FIG. 3, any one or more of the elements illustrated in FIG. 1 and FIG. 2 may be implemented as or within an information handling system exemplified by the information handling system 300 illustrated in FIG. 3. The illustrated information handling system includes one or more general purpose processors or CPUs 301 communicatively coupled to a memory resource 310 and to an input/output hub 320 to which various I/O resources and/or components are communicatively coupled. The I/O resources explicitly depicted in FIG. 3 include a network interface 340, commonly referred to as a NIC (network interface card), storage resources 330, and additional I/O devices, components, or resources 350 including as non-limiting examples, keyboards, mice, displays, printers, speakers, microphones, etc. The illustrated information handling system 300 includes an embedded controller EC 130 may provide or support various system management functions and, in at least some implementations, keyboard controller functions. Exemplary system management functions that may be supported by EC 130 include thermal management functions supported by pulse width modulation (PWM) interfaces suitable for controlling system fans, power monitoring functions support by an analog-to-digital (ADC) signal that can be used to monitor voltages and, in conjunction with sense resistor, current consumption per power rail. This information could be used to, among other things, monitor battery charging or inform the user or administrator of potentially problematic power supply conditions. EC 130 may support battery management features to control charging of the battery in addition to switching between the battery and AC adapter as the active power source changes or monitoring the various battery status metrics such as temperature, charge level and overall health. EC 130 may support an Advanced Configuration and Power Interface (ACPI) compliant OS by providing status and notifications regarding power management events and by generating wake events to bring the system out of low power states.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An information handling system, comprising:
a central processing unit (CPU);
an embedded controller (EC) communicatively coupled to the CPU; and
a computer readable medium including processor executable instructions that, when executed, cause the EC to perform operations including:
monitoring password activity; and
responsive to detecting the password activity satisfying a criterion, taking action to restrict access in accordance with a security policy.

2. The information handling system of claim 1, wherein monitoring password activity includes monitoring unsuccessful password change and password unlock attempts.

3. The information handling system of claim 2, wherein monitoring unsuccessful password change and password lock attempts includes monitoring unsuccessful preboot password change and password lock attempts.

4. The information handling system of claim 2, wherein monitoring unsuccessful password change and password lock attempts includes monitoring password change and password lock attempts on each of a plurality of boot paths, wherein the plurality of boot paths includes an operating system (OS) boot path, a network OS boot path, and a service OS (SOS) boot path.

5. The information handling system of claim 4, further comprising maintaining an OS boot source as a telemetry event.

6. The information handling system of claim 2, wherein monitoring password change and password unlock attempts includes monitoring how many unsuccessful password change and unlock attempts have occurred since a most recent successful password change or password unlock attempt.

7. The information handling system of claim 1, wherein taking action to restrict access includes at least one of:
enforcing an operating system (OS) sign on; and
enforcing a cloud based login with proof of presence.

8. The information handling system of claim 1, wherein taking action to restrict access includes, responsive to detecting an unsuccessful attempt to change or unlock a basic input/output system (BIOS) password while a safe mode is active, prohibiting boot deviations.

9. The information handling system of claim 1, further comprising:
advertising brute force attack attempts with time and date information and maintaining the device in a locked state until a cloud issued token is received.

10. The information handling system of claim 1, further comprising:
responsive to receiving risk assessment information indicative of risk level, dynamically tuning the criterion in accordance with the risk level.

11. A method comprising:
monitoring, by an embedded controller of an information handling system, password activity; and
responsive to detecting the password activity satisfying a criterion, taking action to restrict access in accordance with a security policy.

12. The method of claim 11, wherein monitoring password activity includes monitoring unsuccessful password change and password unlock attempts.

13. The method of claim 12, wherein monitoring unsuccessful password change and password lock attempts includes monitoring unsuccessful preboot password change and password lock attempts.

14. The method of claim 12, wherein monitoring unsuccessful password change and password lock attempts includes monitoring password change and password lock attempts on each of a plurality of boot paths, wherein the plurality of boot paths includes an operating system (OS) boot path, a network OS boot path, and a service OS (SOS) boot path.

15. The method of claim 14, further comprising maintaining an OS boot source as a telemetry event.

16. The method of claim 12, wherein monitoring password change and password unlock attempts includes monitoring how many unsuccessful password change and unlock attempts have occurred since a most recent successful password change or password unlock attempt.

17. The method of claim 11, wherein taking action to restrict access includes at least one of:
enforcing an operating system (OS) sign on; and
enforcing a cloud based login with proof of presence.

18. The method of claim 11, wherein taking action to restrict access includes, responsive to detecting an unsuccessful attempt to change or unlock a basic input/output (BIOS) password while a safe mode is active, prohibiting boot deviations.

19. The method of claim 11, further comprising:
advertising brute force attack attempts with time and date information and maintaining the device in a locked state until a cloud issued token is received.

20. The method of claim 11, further comprising
responsive to receiving risk assessment information indicative of risk level, dynamically tuning the criterion in accordance with the risk level.
